(19) United States
(12) Patent Application Publication
(10) Pub. No.: US 2023/0077023 A1
(43) Pub. Date: Mar. 9, 2023

(54) METHOD AND SYSTEM FOR PROVIDING LIFESTYLE-BASED FUNERAL INSURANCE

(71) Applicant: EMUNA INSURANCE CORP, Lincolnwood, IL (US)

(72) Inventor: Marco E. Santos Reyes, Chicago, IL (US)

(73) Assignee: EMUNA INSURANCE CORP, Lincolnwood, IL (US)

(21) Appl. No.: 17/467,350

(22) Filed: Sep. 6, 2021

(51) Int. Cl. G06Q 50/18; G06Q 40/08

(52) U.S. Cl. CPC G06Q 50/186; G06Q 40/08

(57) ABSTRACT

Method and apparatus for a system to efficiently organize and provide a funeral for a decedent. Unfortunately, the prior art processes of planning and organizing funerals are done with little thought towards the desires of the decedent and are done in a cost insensitive manner. As a result, funerals are often either utterly non-responsive to the desires of the decedent and due to cost constraints, are either lacking in substance or reflect a rushed process which magnifies the pain and loss of the decedent's survivors and mourners. The instant invention addresses all of these problems by allowing a person to plan out, contract, and fully finance their funeral, resulting in a process that provides true dignity and respect to the decedent and spare the mourners the burden of dealing with crass commercial matters in their time of intense grief.

### FIELD OF TECHNOLOGY

This disclosure relates to enhancing performance of a computer system. Specifically, the disclosure relates to enhancing the performance of software applications used by the insurance industry.

### BACKGROUND OF THE DISCLOSURE

One of the most stressful aspects bereaved face when a loved one has passed away is the tension between (1) trying to provide the deceased with a respectful and dignified send off and (2) the problems inherent in the urgent need to immediately procure services in a field that the bereaved is utterly unfamiliar with. Funeral insurance is a mechanism intended to remedy this tension, allowing the bereaved to focus on their personal loss and not on the tedious financial or organizational steps of a funeral. Resolving this tension is beneficial both to the mental and financial health of the bereaved as well as to the social fabric of the community.

Some examples of addressing funerals are listed in U.S. Pat. Nos. 11,050,970, 11,049,610, 11,045,378, 10,954,688, 10,949,937, and 10,839,569. Funeral insurance (sometimes called final expense coverage) is a type of whole life insurance that is specifically marketed to cover final expenses, including those for burial and cremation. This makes final expense coverage different when compared to traditional life insurance policies, which are usually purchased in order to replace income and cover regular living expenses for families when a parent or another breadwinner passes away. Where traditional life insurance is often purchased in amounts of $250,000, $500,000, $1 million, or more, burial insurance typically comes in amounts up to $25,000. As a result, policies are generally less expensive. Burial insurance also tends to be guaranteed, meaning you cannot be denied coverage regardless of your health. And since burial insurance lasts for a lifetime and never expires, this type of coverage can provide considerable peace of mind. Some examples of addressing insurance needs (possibly for funeral or otherwise) are addressed in U.S. Pat. Nos. 11,051,163, 11,049,184, 11,049,183, 11,042,944, 11,042,941, 10,970,789, 10,970,787, 10,963,969, 10,963,966, 10,949,927, 10,878,506, and 10,861,027.

Unfortunately, despite its usefulness, funeral insurance, often due to lack of familiarity with its existence, or due to procrastination, is purchased far less frequently than its utility would suggest. Therefore, there is a need for streamlining the process of applying for and processing funeral insurance policy applications.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 is a first drawing illustrating a device for applying for funeral insurance.

FIG. 2 is a list of processes performed by a device for applying for funeral insurance.

FIG. 3 is a second drawing illustrating a device for applying for funeral insurance.

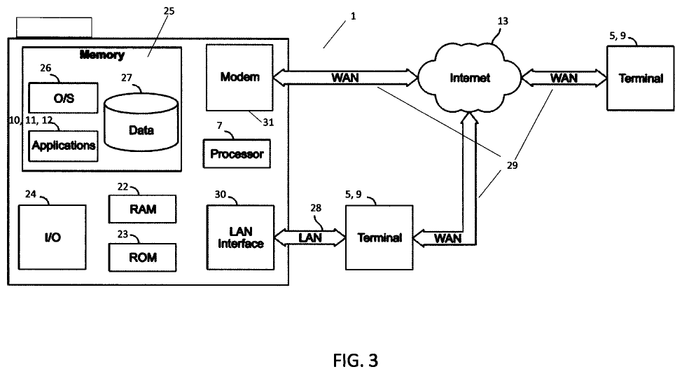

For the purposes of this disclosure, like reference numerals in the figures shall refer to like features unless otherwise indicated. The drawings are only an exemplification of the principles of the invention and are not intended to limit the disclosure to the particular embodiments illustrated.

### BRIEF SUMMARY

To satisfy the long-felt needs and unsolved difficulties identified above, at least one embodiment may be directed toward an apparatus and/or a system for generating an insurance policy application. The apparatus and/or system may include a data processing device. The apparatus and/or system may include method/process steps. The device may be used to perform one or more of the steps. The device may include executable code embodied in a non-transitory computer readable medium. The code, when executed, may be configured to drive executions of a plurality of software applications. The software is constructed and arranged to collect user choices regarding the details of a funeral for a specified person before the death of the specified person. The device may format the user choices into a data file configured for processing by an insurance application processing system. The device may transmit the data file to an insurance application processing system. The device may convince the user of the mortality of human life. The device may convince the user of the value of bequeathing money to loved ones. The device may calculate the expected premium of an insurance policy correlated to the user choices.

In at least one embodiment, the system protects funeral integrity. The system comprises a device including executable code embodied in a non-transitory computer readable medium, the code, when executed, configured to drive executions of a plurality of software applications. Funeral integrity is defined as a funeral configuration desired by a user prior to use of the device. The device is configured to: display an image presenting a cost; display an image presenting a list of categories of funerals; receive data indicating the category of funeral input by a user; repeatedly display choices and receive selections input by a user indicating dependent selections associated with the category of funeral input by the user; repeatedly update the displayed cost image to one associated with the selections; generate a data file including a plurality of selections whose configuration has more than 90% funeral integrity; and transmit the data file to an insurance application processing system.

In at least one embodiment, the configuration has up to 100% funeral integrity.

In at least one embodiment, the category of funeral is one selected from the list consisting of: cremation, casket burial, burial at sea, open casket, closed casket, crematorium cremation, pyre cremation, and composting.

In at least one embodiment, the dependent selections are one selected from the list consisting of: type of urn, type of casket, type of flowers, arrangement of flowers, funeral service location, burial location, location of disposition of remains, service details, song list, music list, dress code, specific persons performing specific actions, specific persons performing specific rituals, eulogy text, invitation details, invitee list, and food provided.

In at least one embodiment, the data file corresponds to an arrangement pre-determined to be consistent with approval guidelines of an insurance company.

In at least one embodiment, the device further prompts for selection of a specific vendor to provide one or more of the dependent selections.

In at least one embodiment, the guidelines are for the approval of sale of an insurance policy by the insurance application processing system.

In at least one embodiment, the insurance policy includes a clause which call for direct payment to the specific vendor independent of communication with any policy beneficiary.

In at least one embodiment, the device further comprises steps of executing contracts with the vendors to provide the dependent selections prior to the date of a funeral.

In at least one embodiment, the insurance policy includes a clause which prohibits any policy beneficiary to alter or adjust a dependent selection.

In at least one embodiment, the insurance policy includes a residuary payment and includes a clause which allows for additional payments to be made to vendors other than those identified as dependent selections.

At least one embodiment of the invention is a system for applying for funeral insurance. The system comprises: a device including executable code embodied in a non-transitory computer readable medium, the code, when executed, configured to drive executions of a plurality of software applications. The device is configured to: collect user choices regarding the details of a funeral for a specified person before the death of the specified person, format the user choices into a data file configured for processing by an insurance application processing system, transmit the data file to an insurance application processing system.

In at least one embodiment, the device convinces the user of the mortality of human life.

In at least one embodiment, the device convinces the user of the value of bequeathing money to loved ones.

In at least one embodiment, the device calculates the expected premium of an insurance policy correlated to the user choices.

At least one embodiment of the invention is a method for protecting funeral integrity. The method comprises: providing and activating a device. The device is constructed and arranged to prepare a data file containing data associated with a detailed description of a funeral service for a person; transmit the data file to an insurance company, the data file including an acceptable offer to purchase an insurance policy; receive a reply from the insurance company which accepts the offer and executes a contract to finance the funeral; the insurance company executes contracts with vendors specifically identified in the data file; and upon passing of the person, providing a funeral service including services provided by the vendors which corresponds with both the detailed description of a funeral service and has funeral integrity, wherein funeral integrity is defined as a funeral configuration desired by a user prior to preparation of the data file.

### DETAILED DESCRIPTION OF THE DISCLOSURE

### Definitions

“Device” means any non-transitory logic-using medium or electronics configured for data processing or to transmit user input and process, store, transmit and/or output data; and includes, but is not limited to, personal computers, business computers, laptop computers, tablet devices, computer networks, software applications, web browsers, short message service (“SMS”) devices, SMS software, email devices, email software, electronic data devices, cell phones, cell phone applications, firmware, websites, cloud-based processing, internet routers, web servers, computer terminals, personal data assistances, any component thereof, any device integrated with any of the aforementioned, and any combination thereof.

“Real-time” describes an attribute of a process in which data is received, processed and a response is issued within a discrete deadline time constraint. The deadline may range from between 0.0001 microseconds and 10 seconds.

“Client” means a specific software or hardware device operating within the distributed data environment.

“User” means a specific application and/or a human interacting with the distributed data environment.

“Configuration” means a record of the arrangement of some or all of the functional units of the distributed data environment according to their nature, number, and/or chief characteristics. The functional units may include the specific types of hardware (including, but not limited to, the name-nodes, data-nodes, and master-node of a distributed data environment), software, firmware and documentation, as well as selected settings of variable operating parameters.

### Embodiments

Various forms of life insurance are designed to protect a policyholder's beneficiaries in the event of an insured person's death. Typically, the death benefit can help compensate a family for the deceased person's lifetime income or provide cash to pay any debts or business expenses they left behind. One item often overlooked with life insurance is the cost and difficulties inherent in actually tending to the funeral of the deceased person. In addition, if not previously considered, a mismatch may develop between the actual choices made by the survivors of the deceased and the choices that the deceased would have preferred. Awareness of this mismatch may lead to significant stress and pain to those already suffering due to the loss of the deceased. In addition, lack of forethought or planning may result in the deceased feeling guilty if they do not “overspend” on the funeral. These problems can be resolved by having an insurance policy in place that both covers the cost of the funeral, and which has already pre-planned the mechanism and arrangements of the funeral.

One item often overlooked with regards to funerals is the disconnect between what a person wants at their funeral and the method with which it is in fact arranged. Funeral arrangement are, at best buried within sales material for life insurance policies and do not solicit funeral specific needs or requests. Instead, they are embedded within systems directed towards finances and monetary benefits. While this state of affairs would be bad enough, because they are within the context of a different category of concern (financial instead of funeral) those concerned with theory funeral arrangement would be actively dissuaded form addressing their funeral after being bombarded with information and questions directed towards finances, and recipients of payouts. Thus, unfortunately, prior art insurance systems actively teach away planning the activity and financing of funerals.

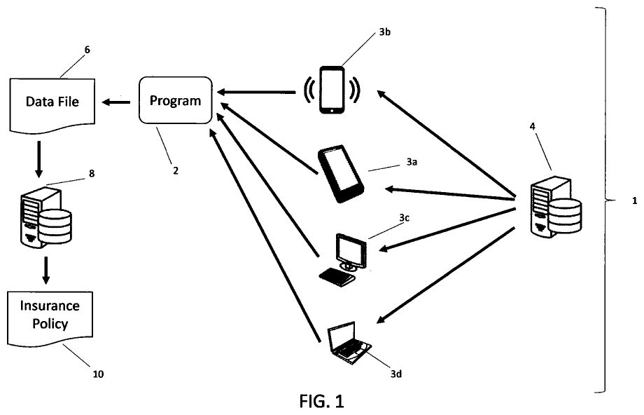

As illustrated in FIG. 1, in at least one embodiment, a system (1) is provided to generate a funeral insurance policy (10). A user is induced to operate a User-Device (3) in data communication with an Insuring-Device (4). The Insuring Device downloads a computer program (2) onto the User-Device (3). The computer program may operate on one or more User-Devices, including but not limited to a tablet (3a), cell phone (3b), desktop computer (3c), laptop computer (3d) or any other Device. The user may be a policy holder of an already extant insurance policy or may be a potential purchaser of one or more insurance instruments. The Insurer-Device (4) may comprise one or more servers (4a, 4b).

In at least one embodiment the user operates the computer program (2) at the inducement of an offeror. The offeror may be a fiduciary such as a guardian, attorney or accountant, may be an insurance broker or salesman, or may be a medical professional. The offeror may have an already existent relationship with the user and is attempting to encourage the user to apply for funeral insurance.

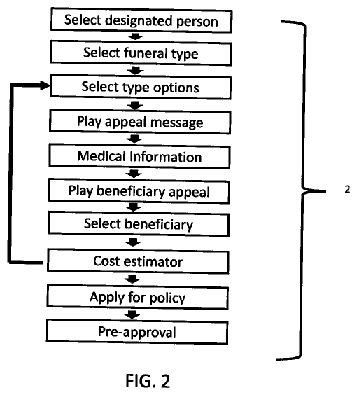

In at least one embodiment, the computer program (2) deploys logic corresponding to one or more of those steps listed in FIG. 2.

In at least one embodiment the program queries the user whether they wish to plan for the funeral arrangement of one or more dedicated persons. The dedicated person may be the user themselves, or someone known by the user. At least some identifying information of the dedicated persons is uploaded to one or more of the Insurer-Devices (4).

In at least one embodiment the program queries the user whether they wish to select from one or more categories of funeral services. These categories of funeral services may include one or more of: cremation, direct burial, graveside service, committal funeral service, burial at sea, composting, and green/natural burial.

In at least one embodiment, the program (3) further offers the user to select from one or more options associated with the selected form of funeral service. For example, if a cremation funeral were selected, the program may offer the user to select if and what type of the following should be present at the service: urns, flowers, cemetery of choice, cemetery location, ash scattering, religious service, one or more alternative religious options.

In at least one embodiment, if a burial funeral were selected, the program may offer the user to select if and what type of the following should be present at the service: casket, flowers, cemetery location, gravestone type, burial container, above/below ground deposition, religious service, one or more alternative religious options.

In at least one embodiment, the program queries the user for one or more geographic regions where the service is to take place or may even query for more than one geographic region if the service is to take place in more than one geographic region. In at least one embodiment, the system conducts a search of cemeteries and only lists geographic regions of those locales containing a cemetery. In at least one embodiment, availability, the rules, laws or procedures of a cemetery are compared to the selected funeral and the user is notified if the selected funeral is not available in the selected cemetery or selected geographic region. In at least one embodiment the geographic region is represented by and/or corresponds to a postal service zip code.

In at least one embodiment the program includes a medical appeal. The medical appeal is a message regarding the mortality of human life. The message may be an audio or video message streamed or broadcast to the User-Device. The message may be presented by a medical professional (such as a doctor, medic, paramedic, nurse) or a clergy member. The message may help to induce the user to purchase a funeral insurance policy. The message may be pre-recorded or a live broadcast or stream. This appeal may cause an emotional connection between the user and the service encouraging the user to persevere through the various stages of the program.

In at least one embodiment, the program (3) queries the user regarding the medical condition of the dedicated person. This query may involve one or more of the dedicated person's pre-existing medical condition, medicines currently or previously used, medical history, family medical history, smoking status, age, height, weight, or date of birth. In at least one embodiment a pre-selected list of medical questions is presented to the user.

In at least one embodiment, the program (3) queries the user to identify beneficiaries. These will be the beneficiaries of the resulting insurance policy.

In at least one embodiment a beneficiary appeal is made to the user. The beneficiary appeal is a message regarding the importance of surviving family. The message may be an audio or video message streamed or broadcast to the User-Device. The message may express the importance of a final expression of love and care to the bereaved as a sign of how important they are to the dedicated person. The message may be followed up by a request for a personalized message to be presented to some or all of the funeral attendees.

In at least one embodiment, the program (3) queries if one or more beneficiaries are to receive one or more bequeaths before, during or after the funeral. The funding source for the bequeath may be financed by the insurance policy or by another funding source.

In at least one embodiment, the program (3) will calculate the cost of the selected funeral. This calculation may include presenting the user one or more choices of premium models to cover the costs. The program (3) may also allow the user to change or adjust their selection to generate various alternative funeral options.

In at least one embodiment the beneficiaries are explicitly referred to in the program as “loved ones”.

In at least one embodiment, the user is prompted to increment the bequeaths by an amount equal to 1-1000 units of local currency (dollars in the USA).

In at least one embodiment the user is prompted to enter financial information used to pay the expected premiums of the insurance policy.

In at least one embodiment an explanatory message is made to the user. The explanatory message is a message describing the manner in which premiums are calculated and what factors adjust the costs. The components of the message may be adjusted to conform to one or more selections made by the user. The message may be an audio or video message streamed or broadcast to the User-Device. The message may be followed up by alternative choices for funeral selections.

In at least one embodiment the program (3) comprises a process for pre-approving or denying an application. While an insurance policy cannot legally issue without first passing a formal underwriting process, an algorithm may be included in the program which simulates the underwriting process. The program can receive the user's selections, apply the algorithm and output a prediction of what the underwiring process. The output may include a message of congratulations for being pre-approved. The output may be generated in Real-Time.

A real world example of use of the invention could be as follows: a user accesses the device/system. A user is given a first choice of type of funeral such as cremation, burial or any other type. After making a selection the user is then prompted to give a series of detailed follow up answers dependent on one or more previous answers. For example after indicating that they want a cemetery funeral, the user could be prompted to indicate which exact cemetery they wish to be buried in, who exactly do they want to preside over the service (for example do they have a specific house of worship to be affiliated with the service or should some of the service take place there, or do they want a specific cleric or officer of that house of worship to preside). Other questions would be what kind of service, what sorts of accoutrements should be there (music, kinds of music, playlists, bands/performers) or decorations (flowers, what kinds of bouquets, what species of flowers, where should they be located (on/off a casket), what sort of dress code should be present or any other specific they care for. Is there a specific inscription or quote to be placed on an urn or tombstone, or be displayed at the cemetery?

A example of the series of questions and answers could be as follows: (1) cremation or burial—after selecting burial, (2) where should it occur—after selecting a city, county or state (3) should there be a eulogy—after yes; (4) insert subjects to address in the eulogy—after which; (5) should the services correspond to a religion and list various religions (Christianity, Judaism, Islam, Mormonism . . . etc.)—after which if one is selected; (6) is there a house of worship where some or all of a service should occur or should be contacted to recruit a clergyperson . . . .

In at least one embodiment the system includes prices associated with each of the selections and displays the cost of a funeral associated the various choices made. The system may also calculate which insurance policies can finance such a service and payment mechanism for purchasing such a service (co-pays, premiums, down payments).

In an embodiment, the system also facilitates the calculation of the prices by applying the selections to various different insurance instruments. For example, the insurance policy may be a life insurance policy which is whole life, variable revocable or irrevocable. In at least one embodiment the system sets up a trust (which can be a legal personality such as a corporation) which is a designated beneficiary of a payment upon passing of the insured and which can guarantee that allocated funds are only utilized for the exact category of funeral chosen by the decedent.

In an embodiment the policy allows for heirs or designees of the decedent to alter or adjust the planned funeral to produce something with one or more different selections than was chosen by the decedent. In one embodiment this cannot occur.

In at least one embodiment, contracts are executed binding one or more vendors who will provide one or more of the selections made by the user before the funeral. As a result, the descendant may interact with and view examples of the funeral before their passing.

In at least one embodiment, the system also queries for selections of health and legal matters such as but not limited to current or previous: medication taken, medical conditions, family medical history, genetic predispositions, eating habits, smoking habits, weight, arrest record, credit rating, criminal history, marital status, sexual partners, sexually transmitted disease status, income, wealth, race, sex, gender, and mental conditions. In at least one embodiment the system calculates the price of purchasing an insurance policy taking into account these various selections.

In at least one embodiment the system utilizes a layaway model in which a number of payments would need to be made before the funeral benefit is vested. The number f payments to vest may be displayed as well indicating how long a user needs to pay before they can be assured of the funeral they want. One or more or all the selections may be substituted with a non-selected option if the decedent passes before the full layaway payment plan is paid off.

This invention thus help address the problem of funeral integrity. In an embodiment, the user may assign a relative weight to each selection queried for by the device. In this manner each selection can be accorded a proportional value relative to the overall value of the entire funeral. Funeral integrity is the measure of how closely the exact funeral that occurs in fact matches the ideal funeral that the user wishes for. For example, table 1 illustrates how funeral integrity may operate.

TABLE 1

| Selection | Category | Relative Weight |
|---|---|---|
| First Baptist Church | Church Service | 2.5 |
| 10 Main Street | | |
| Springfield, Alaska | | |
| Christian - Baptist | Religion | 2.5 |
| Pastor of the | Clergy | 2.5 |
| selected church | | |
| Wood Coffin | Casket | 2.5 |
| White Roses | Accoutrement | 5 |
| National Military | Cemetery | 25 |
| Cemetery | | |
| Mention Military | Sermon | 25 |
| Service | | |
| Invite Regiment | Invitees | 20 |
| Colleagues | | |
| Children | Invitees | 5 |

In Table 1, it is quite clear that the decedent considers his military service to be of very high importance and his religious affiliation to be of less significance. As a result, were the funeral to loyally address his military concerns but ignore his religious concerns, the result would impart a much higher level of funeral integrity than if the religious concerns were loyally addressed but the religious concerns were ignored. Similarly, Table 1 shows that for any selection (in this case Invitees) there can be more than one selection and those specific selections can have different weights.

In an embodiment, the user may specify a maximum budget for premiums or costs of the funeral. Furthermore, if the only resulting funeral that can occur will be below a specific threshold of funeral integrity, some or all of funds previously dedicated to the funeral are instead given to heirs or beneficiaries and a much cheaper funeral is to be performed.

In an embodiment, the system is capable of calculating the funeral integrity of various combinations of selections and can provide various alternative funeral configurations which has some selections removed or replaced with lower cost alternatives. In an embodiment the system provides the funeral configuration with the highest funeral integrity value that is within the applicable budget.

In an embodiment, one some or all of the selections are in fact implemented at a funeral.

In at least one embodiment the funeral integrity is from 0% to 100% exclusive and/or inclusive at either or both ends. In other embodiments the level of funeral integrity if within one of the ranges of 5%-95%, 2%-20%, 85%-100%, 80%-99%, 50%-75%.

In at least one embodiment the program (3) generates a data file (6) containing some or all of the user selections. The data file (6) can be arranged in a pre-determined format suitable for receipt by an insurance company's application processing software. The insurance company's application processing software may reside on the same Device as the Insuring-Device (4) or may reside on one or more other Devices.

In an embodiment, the generated data file also includes meta-data. Meta-data is data associated with information that provides descriptive attributes of data. Three distinct types of meta-data items exist: descriptive meta-data, structural meta-data, and administrative meta-data. The search for segment units may involve perusing all three types of meta-data for the affirmation.

Descriptive meta-data describes information associated with discovery and identification. It can include elements such as the types of applications, and the specific program (3) which generated it. Structural meta-data is meta-data describing information associated with containers of data and indicates how compound objects were put together, for example, how pages are ordered to form chapters. It includes the types, versions, relationships and other characteristics of digital materials. Administrative meta-data describes information associated with managing resources, such as when, where, and how a file was created; file type; and other technical information; and who can access the file.

Any one, some, or all the constituents of the system (1), program (3), including some or all of a distributed data environment, including any or all of its services, nodes, clusters, blocs, and constituents thereof, may manifest within one or more computer systems. As illustrated in FIG. 6, the computer system (1) may have a processor (7) for controlling the operation of associated components, and may include RAM 22, ROM 23, input/output modules 24 and a memory 25. Processor (7) may also execute all software running on the Device—e.g., operating system (26), consent and authorization applications (10, 11, 12). Other components commonly used for Devices such as EEPROM or Flash memory or any other suitable components may also be part of the computer system.

The memory of the computer system may include any suitable permanent storage technology—e.g., a hard drive or cloud based storage. The memory stores software, including operating system (26), any application(s) (10, 11, 12), and data (27) needed for the operation of the computer system (1). Alternatively, some or all of computer executable instructions may be embodied in hardware or firmware. The computer executes the software instructions to perform various functions.

The Device may be connected to other computer systems via a local area network (LAN) (28), a wide area network (WAN) (29), or other network arrangement. The system may operate in a networked environment supporting connections to one or more remote computers, such as terminals (5, 9), personal computers, or servers that include many or all of the elements described above relative to system. The network may be interconnected via modems (31) interfaces (30) or other communication medium including the internet (13).

It will be appreciated that any known network connections or other means of establishing a communications link among the computers may be used. The existence of any of various well-known protocols such as TCP/IP, Ethernet, FTP, HTTP and the like is presumed, and the system can be operated in a client-server configuration to permit a user to retrieve applications such as web pages from a web-based server. Any of various conventional web browsers can be used to display and manipulate data on web pages.

The computer system may also include one or more of the following components: I/O circuitry that may include a transmitter device and a receiver device and that may interface with fiber optic cable, coaxial cable, telephone lines, wireless devices, PHY layer hardware, a keypad/display control device or any other suitable encoded media or devices; peripheral devices that may include counter timers, real-time timers, power-on reset generators or any other suitable peripheral devices; and logical processing device that may compute data structural information or structural parameters. Components of the computer system may be coupled together by a system bus or other interconnections and may be present on one or more circuit boards. In some embodiments, the components may be integrated into a single chip. The chip may be silicon-based.

While this invention may be embodied in many different forms, there are described in detail herein specific preferred embodiments of the invention. The present disclosure is an exemplification of the principles of the invention and is not intended to limit the invention to the particular embodiments illustrated. All patents mentioned herein (including within the background of the disclosure), are incorporated by reference in their entirety. Furthermore, the invention encompasses any possible combination of some or all of the various embodiments described herein and/or incorporated herein and in any possible order or sequence other than those stated herein. In addition, the invention encompasses any possible combination that also specifically excludes any one or some of the various embodiments described herein and/or incorporated herein.

The above disclosure is intended to be illustrative and not exhaustive. This description will suggest, many variations and alternatives to one of ordinary skill in this art. All the alternatives and variations are intended to be included within the scope of the claims where the terms “comprising,” and “including” mean “comprising/including, but not limited to”. Those familiar with the art may recognize other equivalents to the specific embodiments described herein which equivalents are also intended to be encompassed by the claims.

Those skilled in the art may recognize other equivalents to the specific embodiment described herein which equivalents are intended to be encompassed by the claims attached hereto.

What is claimed is:

1. A system for protecting funeral integrity, the system comprising:
a device including executable code embodied in a non-transitory computer readable medium, the code, when executed, configured to drive executions of a plurality of software applications,
wherein funeral integrity is defined as a funeral configuration desired by a user prior to use of the device;
the device configured to:
display an image presenting a cost;
display an image presenting a list of categories of funerals;
receive data indicating the category of funeral input by a user;
repeatedly display choices and receive selections input by a user indicating dependent selections associated with the category of funeral input by the user;
repeatedly update the displayed cost image to one associated with the selections;
generate a data file including a plurality of selections whose configuration has more than 90% funeral integrity.
transmit the data file to an insurance application processing system.

2. The device of claim 1 wherein the configuration has 100% funeral integrity.

3. The device of claim 1 wherein the category of funeral is one selected from the list consisting of: cremation, casket burial, burial at sea, open casket, closed casket, crematorium cremation, pyre cremation, and composting.

4. The device of claim 1 wherein the dependent selections are one selected from the list consisting of: type of urn, type of casket, type of flowers, arrangement of flowers, funeral service location, burial location, location of disposition of remains, service details, song list, music list, dress code, specific persons performing specific actions, specific persons performing specific rituals, eulogy text, invitation details, invitee list, and food provided.

5. The device of claim 1 wherein the data file corresponds to an arrangement pre-determined to be consistent with approval guidelines of an insurance company.

6. The device of claim 1 wherein the device further prompts for selection of a specific vendor to provide one or more of the dependent selections.

7. The device of claim 6 wherein the guidelines are for the approval of sale of an insurance policy by the insurance application processing system.

8. The device of claim 6 wherein the insurance policy includes a clause which call for direct payment to the specific vendor independent of communication with any policy beneficiary.

9. The device of claim 6 further comprising the steps of executing contracts with the vendors to provide the dependent selections prior to the date of a funeral.

10. The device of claim 6 wherein the insurance policy includes a clause which prohibits any policy beneficiary to alter or adjust a dependent selection.

11. The device of claim 6 wherein the insurance policy includes a residuary payment and includes a clause which allows for additional payments to be made to vendors other than those identified as dependent selections.

12. A system for applying for funeral insurance, the system comprising:
a device including executable code embodied in a non-transitory computer readable medium, the code, when executed, configured to drive executions of a plurality of software applications,
the device configured to:
collect user choices regarding the details of a funeral for a specified person before the death of the specified person,
format the user choices into a data file configured for processing by an insurance application processing system,
transmit the data file to an insurance application processing system.

13. The system of claim 12 wherein the device convinces the user of the mortality of human life.

14. The system of claim 12 wherein the device convinces the user of the value of bequeathing money to loved ones.

15. The system of claim 12 wherein the device calculates the expected premium of an insurance policy correlated to the user choices.

16. A method for protecting funeral integrity, the method comprising:
providing a device, the device constructed and arranged to:
prepare a data file containing data associated with a detailed description of a funeral service for a person;
transmitting the data file to an insurance company, the data file including an acceptable offer to purchase an insurance policy;
receiving a reply from the insurance company which accepts the offer and executes a contract to finance the funeral;
the insurance company executing contracts with vendors specifically identified in the data file; and
upon passing of the person, providing a funeral service including services provided by the vendors which corresponds with both the detailed description of a funeral service and has funeral integrity, wherein funeral integrity is defined as a funeral configuration desired by a user prior to preparation of the data file.
